(19) United States
(12) Patent Application Publication
(10) Pub. No.: US 2023/0197955 A1
(43) Pub. Date: Jun. 22, 2023

(54) CARBON ANODE MATERIALS

(71) Applicant: FARADION LIMITED, Sheffield (GB)

(72) Inventors: Jeremy BARKER, Sheffield (GB); Sheyyed Shayan MEYSAMI, Sheffield (GB); Francesco MAZZALI, Sheffield (GB)

(21) Appl. No.: 17/925,893

(22) PCT Filed: May 21, 2021
(86) PCT No.: PCT/GB2021/051251

§ 371 Date: Nov. 17, 2022

(30) Foreign Application Priority Data
May 21, 2020 (GB) 2007627.9

(51) Int. Cl. H01M 4/587; H01M 10/0568; H01M 10/0569; H01M 10/0525; H01M 10/054

(52) U.S. Cl. CPC H01M 4/587; H01M 10/054; H01M 10/0525; H01M 10/0568; H01M 10/0569; H01M 2004/027

(57) ABSTRACT

The invention relates to a carbon-containing anode material which is capable of the insertion and extraction of alkali metal ions and which has a carbon structure comprising a core comprising one or more primary carbon-containing materials. The invention further relates to the preparation of such carbon-containing anode material.

### FIELD OF THE INVENTION

The present invention relates to certain novel carbon-containing anode materials, to a novel process to produce such carbon-containing anode materials, to anode electrodes which contain such novel carbon-containing anode materials and to the use of such anode electrodes in, for example, energy storage devices such as batteries (especially rechargeable batteries), electrochemical devices and electrochromic devices.

### BACKGROUND OF THE INVENTION

Sodium-ion batteries are analogous in many ways to the lithium-ion batteries that are in common use today; they are both reusable secondary batteries that comprise an anode (negative electrode), a cathode (positive electrode) and an electrolyte material, both are capable of storing energy, and they both charge and discharge via a similar reaction mechanism. When a sodium-ion (or lithium-ion) battery is charging, Na⁺ (or Li⁺) ions are extracted from the cathode and insert into the anode. Meanwhile charge balancing electrons pass from the cathode through the external circuit containing the charger and into the anode of the battery. During discharge the same process occurs but in the opposite direction.

Lithium-ion battery technology has enjoyed a lot of attention in recent years and provides the preferred portable battery for most electronic devices in use today; however, lithium is not a cheap metal to source and is considered too expensive for use in large scale applications. By contrast sodium-ion battery technology is still in its relative infancy but is seen as advantageous; sodium is much more abundant than lithium and some researchers predict this will provide a cheaper and more durable way to store energy into the future, particularly for large scale applications such as storing energy on the electrical grid. Nevertheless, a lot of work has yet to be done before sodium-ion batteries are a commercial reality.

Significant research progress has been made in developing cathode electrode materials with high charge storage capacities and rate capability, for both lithium-ion and sodium-ion batteries, however, one area which needs more attention is the development of new and more efficient anode electrode materials.

Carbon, in the form of graphite, has been favoured for some time as an anode material in lithium-ion batteries due to its high gravimetric and volumetric capacity; graphite electrodes deliver reversible capacity of more than 360 mAh/g, comparable to the theoretical capacity of 372 mAh/g. The electrochemical reduction process involves Li⁺ ions being inserted in between the graphene layers, to yield LiC₆. Unfortunately, however, graphite is much less electrochemically active towards sodium and this, coupled with the fact that sodium has a significantly larger atomic radius compared with lithium, results in the intercalation between graphene layers in graphite anodes being severely restricted in sodium-ion cells.

Anodes made using hard carbon materials, on the other hand, (such as described in PCT/GB2020/050872, US2002/0192553A1, US9,899,665B2, US2018/0287153A1) are found to fare much more favourably in sodium-ion cells.

Hard carbons have disordered structures which overcome many of the insertion issues for sodium ions. The exact structure of hard carbon materials has still to be resolved, but in general terms hard carbon is described as a non-graphitisable carbon material lacking long-range crystalline order. Hard carbon has layers, but these are not neatly stacked in long range, and it is a microporous material. Although lacking a definable crystallographic structure, hard carbon is isotropic at the macroscopic level. One of the reasons why it is difficult to construct a universal structural model of hard carbon is that short-range order, domain size, fraction of carbon layers and micropores depend on the synthesis conditions, such as carbon sources, carbonisation and pyrolysis temperatures.

Further still, unlike graphite, which has a graphite crystal structure in which carbon layer planes are stacked in layers, hard carbon has a turbostratic structure in which carbon layer planes are stacked in a state of being three dimensionally displaced. Therefore, the heat treatment of hard carbon, even at high temperature (e.g. 3000° C.) does not result in a transformation from the turbostratic structure to the graphitic structure or the development of graphite crystallites. Thus, hard carbon is structurally quite distinct from graphite and can be said to comprise one or more non-graphitised domains as well as one or more non-graphitisable domains

Usual methods for producing hard carbon materials which may be utilised in electrodes for secondary battery applications involve heating carbon-rich starting materials such as minerals, for example petroleum coke and pitch coke; secondary plant-based materials such as sucrose and glucose; man-made organic materials such as polymeric hydrocarbons and smaller organic compounds such as resorcinol formaldehyde; animal-derived materials such as manure; and primary plant-derived materials such as coconut shells, coffee beans, straw, bamboo, rice husks, banana skins, etc., to temperatures greater than 500° C. in an oxygen-free atmosphere. In the case when plant-derived and animal-derived materials are carbonised, “biochar” or biomass-charcoal is produced which may be further processed to obtain hard carbon material.

On the other hand, soft carbon is another form of carbon that is also structurally distinct from graphite, but it is a graphitisable form of carbon and can transform at high temperature (e.g. 3000° C.) to comprise domains of graphitic structure. However even after this heat treatment, domains of non-graphitised carbon material will still reside because the transformation will not result in a fully graphitic structure. Thus, soft carbon can be said to comprise one or more non-graphitised domains, but cannot be said to comprise one or more non-graphitisable domains.

An important feature of commercially useful anode materials is the inclusion of a solid electrolyte interphase (SEI) layer which naturally forms as a result of liquid electrolyte decomposition products depositing at the interface between the electrolyte and the anode surface during the first charge cycle of pristine alkali metal-ion batteries. It has been realised for some time that this SEI layer is an essential component of an alkali metal-ion battery, firstly because it protects the anode by inhibiting the transfer of electrons from the anode to the electrolyte, and secondly, because it allows the alkali metal ions to transfer from the electrolyte to the anode, and these two factors influence the battery cycle life. An ideal SEI layer is therefore both an ionic conductor and an electrical insulator. However, the formation of the SEI layer necessarily consumes a portion of the alkali metal ions which are extracted from the cathode during the initial charge cycle, and this in turn means that they are unavailable for future charge/discharge cycles. Since there is a fixed inventory of charge carriers in an isolated rechargeable battery, this depletion of available alkali metal ions results in an irreversible loss in capacity. The current work aims to control the formation of the SEI layer (in particular, to control the stability of the SEI layer), in order to maximise its ionic conduction and electronic insulation properties and to minimise the irreversible specific capacity.

As described below, the present applicant has engineered the surface chemistry, morphology, crystallography, thickness and pore structure of anode electrode materials, in order to control the stability and robustness of the SEI layer and thereby to minimise the irreversible capacity of first-cycle loss.

CN 108963252 A discloses an anode material comprising a hard carbon core which is then coated with Binchotan charcoal and heated to 1500° C. However, this process does not result in any engineering to the surface chemistry of the hard carbon material because, even at this high temperature, the hard carbon is unable to chemically bond to the Binchotan charcoal.

Therefore, and in particular, the present invention provides novel carbon-containing anode materials that have an outer surface which is engineered to have particular chemical and/or physical characteristics that can be used to establish an optimised, stabilised and robust SEI layer while minimising the irreversible capacity. Further, the present invention provides a novel process for preparing such surface engineered carbon-containing anode materials. Such a process will be cost effective, especially on a commercial scale and will use readily available reactants. The resulting surface engineered carbon-containing anode materials will be useful in energy storage devices such as batteries (especially secondary (rechargeable) batteries), alkali metal-ion cells (particularly sodium-ion cells), electrochemical devices and electrochromic devices. Importantly, these surface engineered carbon-containing anode materials will produce energy storage devices that deliver excellent results for reversible specific capacity, cathode specific energy, first cathode desodiation specific capacity, and first discharge capacity efficiency (coulombic efficiency, calculated as the ratio of the total charge extracted from the battery to the total charge put into the battery over a full cycle), and significantly reduced irreversible capacity (first cycle loss). Moreover, the novel surface engineered carbon-containing anode materials of the present invention will provide surprising and advantageous handling characteristics compared with a similar non-surface engineered carbon-containing anode materials, such as the anode material disclosed in CN 108963252 A, including a reduction in moisture sensitivity and a reduction in the viscosity of slurries used to prepare electrodes.

To accomplish these aims, the present invention provides a carbon-containing anode material which is capable of the insertion and extraction of alkali metal ions, and which has a carbon structure comprising a core comprising one or more primary carbon-containing materials, and an outer surface comprising one or more carbonised materials, preferably chemically bonded on the one or more primary carbon-containing materials.

As used herein the term “core” means the central part of the carbon structure.

Most preferably, the core does not consist or consist essentially of one or more primary carbon-containing materials selected from graphite and a material that has a fully graphitic structure. In one embodiment, the core may consist essentially of the one or more primary carbon-containing materials, and further preferably may consist of the one or more primary carbon-containing materials.

As used herein the phrase “chemically bonded” means that a chemical bond such as a covalent bond is formed between the one or more primary carbon-containing materials and the one or more carbonised materials. Therefore, “strong bonds” are included within meaning of this phrase, but “weak-bonds” such as van der Waals interactions are not included within the meaning of this phrase.

As the carbonised material is “chemically bonded” to the primary carbon containing material, preferably by the use of chemical vapour deposition according to the present invention, this advantageously allows engineering to the surface of the primary carbon-containing material. Moreover, the carbonised material of the present invention is pyrolytically decomposed on the one or more primary carbon-containing materials, and this “bottom-up synthesis approach” allows carbon atoms to be deposited one by one on the outer surface of the one or more primary carbon-containing materials.

As such, the carbon-containing anode material comprises one or more primary carbon-containing materials with an outer surface which is engineered to exhibit particular surface characteristics as described below, and most ideally the carbon-containing anode material according to the present invention comprises one or more primary carbon-containing materials with an outer surface which is engineered to exhibit an open micropore specific surface area of 0 m²/g to 5 m²/g, as determined using nitrogen gas BET analysis. Preferably, an open micropore specific surface area of greater than 0 m²/g to 5 m²/g, as determined using nitrogen gas BET analysis.

Suitable primary carbon-containing materials are in any particulate (e.g. granular or powdered) form and are capable of the insertion and extraction of sodium ions.

In one embodiment, the one or more primary carbon-containing materials may comprise a domain selected from the group consisting of a non-graphitisable domain and a non-graphitised domain. As discussed above, a hard carbon material is an example of a carbon-containing material that comprises a non-graphitisable domain as well as a non-graphitised domain. A soft carbon material is an example of a carbon-containing material that comprises a graphitisable domain and a non-graphitised domain.

In one embodiment, the one or more primary carbon-containing materials may comprise a graphitisable domain and/or a non-graphitised domain. An example of this is soft carbon.

In one embodiment, the one or more primary carbon-containing materials may comprise a non-graphitisable domain and a non-graphitised domain. An example of this is hard carbon.

In one embodiment, the one or more primary carbon-containing materials comprise disordered carbon-containing materials, and further preferably they include one or more materials selected from conventional carbon anode materials (e.g. hard carbon anode materials); non-fully graphitised high-T hard carbon (for example a hard carbon annealed to temperatures greater than 2000° C., but below 3000° C. when full graphite forms); carbon-metal, carbon-semi-metal or carbon-non-metal composite materials (for example carbon-Sb, carbon-Sn, carbon-Si, carbon-Pb, carbon-Ti and carbon-P) (hard carbon analogues of these materials are especially preferred); soft carbon material (for example pyrolysed milled carbon fibre); a carbon-conductive additive mixture (for example hard carbon-carbon black mixture, a suitable carbon black may be Super C65™ material commercially available from Imerys); a carbon-oxide composite material (for example hard carbon-Fe₂O₃, hard carbon-Sb oxide, hard carbon Sn oxide, hard carbon-Sb/Sn oxide); carbon-carbide composite materials (for example hard carbon-SiC composite material); and activated carbon material (for example activated hard carbon with BET surface area of > 100 m²/g). Conveniently, the primary carbon-containing materials may be produced by the pyrolysis (high temperature treatment, typically greater than 700° C. to 2500° C. and typically under a non-oxidising atmosphere comprising one or more selected from nitrogen, carbon dioxide, another non-oxidising gas and an inert gas such as argon) of carbon-based starting materials such as plant based material, animal-derived material (including “animal-derived waste material” obtained after food has passed through, and has been excreted from, the digestive tract of an animal), hydrocarbon materials (including fossil fuel materials such as coal, coal pitch, coal tar, petroleum pitch, petroleum tar and oil) carbohydrate materials and other carbon-containing organic materials. Preferably, the carbon-based starting materials are purified, ideally prior to pyrolysis, to remove unwanted non-carbon-containing material (for example metal-containing ions (such as transition metals, alkali metals or alkaline earth metals), and non-metal-containing-ions (e.g. phosphorus, oxygen, hydrogen) using process steps that may include one or more selected from charring (typically at a temperature of 150° C. to ≤ 700° C.), washing, decomposition, chemical digestion (for example using acidic and/or alkaline conditions), filtration, centrifugation, ‘heavy media separation’ or ‘sink and float separation’, the use of ion exchange materials, chromatographic separation techniques, electrophoresis separation techniques, the use of complexing agents or chemical precipitation techniques and milling (typically to a d₅₀ particle size of ca. 8-25 µm and filtered through a 15-25 µm sieve to exclude larger particles).

In one embodiment, the particle size distribution of the one or more primary carbon containing materials is from about 1 nm to about 30 µm , preferably from about 1 nm to 20 µm. In particular, the Applicant understands that the surface treatment of the present invention does not substantially alter the particle size distribution of the one or more primary carbon containing materials. Therefore, this range applies to the particle size distribution of the one or more primary carbon containing materials before the carbonised materials are chemically bonded on the one or more primary carbon-containing materials, as well as after this treatment has taken place.

In one embodiment, the one or more primary carbon containing materials have a d₁₀ particle size of about 0.01 µm to about 4 µm.

In one embodiment, the one or more primary carbon containing materials have a d₅₀ particle size of about 4 µm to about 15 µm. In another embodiment, the one or more primary carbon containing materials have a d₅₀ particle size of from about 1 to about 25 µm, preferably of from about 8 to about 25 µm.

In one embodiment, the one or more primary carbon containing materials have a d₉₀ particle size of about 15 µm to about 30 µm.

Ideally, the primary carbon-containing material used in the carbon-containing anode material of the present invention comprises a hard carbon and/or a soft carbon material, and further ideally this hard carbon and/or soft carbon material has a non-fully-graphitic structure, that is, it comprises non-graphitised domains.

Other preferred primary carbon-containing materials comprise carbon (for example hard carbon, soft carbon, as described above), in combination with one or more elements and/or compounds. Particularly preferred example combinations include carbon/X materials, where X may be one or more elements such as antimony, tin, phosphorus, sulfur, boron, aluminium, gallium, indium, germanium, lead, arsenic, bismuth, titanium, molybdenum, selenium, tellurium, silicon, carbon or magnesium. carbon/Sb, carbon/Sn, carbon/SbₓSn_{y}, carbon/phosphorus, carbon/silicon, carbon/silicon carbide (HC/SiC), or carbon/sodium silicate are suitable carbon-containing materials. Hard carbon analogues of one or more of these materials are especially preferred. Further preferred example combinations include carbon/X materials, where X may be one or more oxides of elements selected from the group consisting of antimony, tin, phosphorus, sulfur, boron, aluminium, gallium, indium, germanium, lead, arsenic, bismuth, titanium, molybdenum, selenium, tellurium, silicon, carbon and magnesium.

In some embodiments, the primary carbon-containing material may contain one or more metal and/or non-metal ions which may act as a dopant in the final carbon-containing anode material. These metals and/or non-metal ions may either be added to the primary containing-carbon material prior to treatment with a carbonised material as described below, or be added to the carbon-based starting material used to make the primary carbon-containing material prior to pyrolysis. Alternatively, one or more metal and/or non-metal ions may be selectively retained in the carbon-based starting materials prior to pyrolysis and will therefore be carried through into the primary carbon-containing material.

The surface characteristics of the carbon-containing anode materials according to the present invention have been Investigated using BET techniques to determine the specific surface area of the open micropores, that is micropores which have their open mouth formed at the surface of the carbon-containing anode materials. Herein, the “surface” is literally on the outside of, and at no depth into the body of, the carbon-containing anode particles. Pores denoted as “micropores” are those which have a diameter of less than 2 nm, and they are distinct from “mesopores” which are pores that have a diameter of around 2 nm to 50 nm.

The present Applicant has found that significantly improved electrochemical performance can be achieved in the case of electrochemical cells that employ surface engineered carbon-containing anode materials according to the present invention which have an open micropore specific surface area which is greater than 0 m²/g up to a maximum of 5 m²/g, preferably up to a maximum of 0.9, particularly preferably up to a maximum of 0.5 m²/g, highly preferably up to a maximum of 0.3 m²/g and most preferably up to a maximum of 0.15 m²/g, as determined using nitrogen gas BET analysis.

As mentioned above, the surface engineered carbon-containing anode materials according to the present invention are conveniently produced when one or more primary carbon-containing materials (which are in solid form and preferably in particulate, granular or powered form) are treated with carbonised material. This treatment results in the carbonised material being preferably chemically bonded, more preferably chemically deposited, to the primary carbon containing material, preferably by the use of chemical vapour deposition according to the present invention.

The present invention is not however limited to the use of chemical vapour deposition. Indeed, the skilled person would be aware of alternative methods to chemically bond materials to a primary substrate. Example of these may include plasma-enhanced deposition, atomic-layer deposition and physical vapour deposition.

“Carbonised material” as referred to here is a carbon-rich solid species that is preferably derived from one or more secondary carbon-containing materials. Most particularly the present invention employs such carbonised material as an extremely thin deposit on the outer surface of the one or more primary carbon-containing materials. Although the carbonised material is preferably deposited substantially uniformly over the surface of the inner core, it is important to note that the deposit may not necessarily be in the form of a complete layer or an even coating (i.e. the primary carbon-containing material and deposited carbonised material may not necessarily be in a core/full shell-type arrangement). Nevertheless, the material, where deposited, preferably has a thickness of 1 nm to less than 500 nm, further preferably from 10 nm to less than 500 nm, and highly preferably from 10 nm to 250 nm. Ideally, between 10% to 90% of the surface area of the outer surface of the one or more primary carbon-containing materials will be covered with the carbonised material derived from the one or more secondary carbon-containing materials. The mass of the deposit is also extremely small (typically 2.2 ± 0.8 wt.% per 30 minutes of deposition). Therefore, the carbonised material does not substantially alter the particle size distribution of the one or more primary carbon containing materials as discussed above.

Suitable secondary carbon-containing materials from which the carbonised material is preferably derived, may be selected from one or more organic and/or hydrocarbon materials, for example alkanes, alkenes, alkynes or arenes, which may be straight chained, branched or cyclic. The secondary carbon-containing materials themselves may be derived from coal- or petroleum-based tar or pitch, oil or plant-based materials. Secondary carbon-containing materials which comprise one or more gaseous hydrocarbons with the general formula: CₙH₂ₙ₊₂ where 1 ≤ n ≤ 10, are particularly preferred.

In one embodiment, the secondary carbon-containing materials from which the carbonised material is preferably derived may comprise a vapour and/or a liquid and/or a gaseous phase at, at least one temperature from about 950° C. or less. Preferably, a vapour and/or a liquid and/or a gaseous phase at, at least one temperature between about 200° C. or more to about 950° C. or less.

The specific surface area of the open micropores of the carbon-containing anode materials of the present invention is found to be dramatically lower than the specific surface area of the open micropores of the primary carbon-containing materials prior to treatment with the carbonised material, for example derived from the one or more secondary carbon-containing materials (as described above). It is believed that this is due to the mouth of at least a portion of the open micropores (i.e. those at the surface) of the carbon-containing anode material being “masked” or “plugged” by the deposited carbonised material. Preferably, the presence of the chemically deposited carbonised material derived from one or more secondary carbon-containing materials causes the surface area of the surface micropores of the carbon-containing anode materials to be reduced by at least 40%, further preferably by at least 50% and particularly preferably by at least 85%, compared with the surface area of the open micropores of the primary carbon-containing materials prior to treatment with the carbonised material. The high reduction in open micropore surface area appears to support the Applicant’s current understanding that the deposited carbonised material only plugs the surface (open) micropores, moreover, this belief is further supported by the fact that no significant weight gain in the primary carbon-containing materials can be measured post treatment with carbonised material.

As disclosed above, the present invention provides a carbon-containing anode material comprising carbonised material deposited or partially deposited on the outer surface of a primary carbon-containing material.

The carbonised material may be a “soft” carbon-containing species that will, to some degree, be graphitised by the carbonisation process, and the presence of graphitised material can be verified for example by Raman spectroscopy, X-ray diffraction or high-resolution transmission electron microscopy. However, it is important to control the formation of the carbon-containing anode material such that it has a degree of graphitisation which is suitable for the chemistry of the particular cell in which it is being used. For example, graphitisation in the case of Na-ion cells is highly preferably limited to a level often observed in conventional hard carbon materials, that is, it is desirable to avoid highly graphitised soft carbon-containing species on the surface of the primary carbon-containing material for the purpose of reversible sodiation because graphite is much less electrochemically active towards sodium. The opposite would be the case for lithium-ion cells however.

Care must be taken to avoid the formation of highly graphitic domains as these catalyse various parasitic reactions (e.g. when propylene carbonate (PC) is used in the electrolyte composition). Therefore, extreme annealing is found not to enhance carbon anode efficiency. Surface treatment according to the current invention, on the other hand, is found to systematically improve the efficiency of a carbon-containing anode material, regardless of the electrolyte system. The method of the present invention, however, does not affect the volume of closed pores. This is evident from the fact that primary carbon-containing materials pre- and post-treatment with carbonised material produce similar (de)sodiation potential profiles.

Another preferred characteristic of the surface of the carbon-containing anode materials according to the present invention is an extremely low degree of surface oxygenation. It is known that the presence of compounds with oxygen-containing groups on the surface of the carbon-containing materials (for example C—O, C═O and C(═O)OH functional groups) are liable to act as permanent anchor points for incoming charge carriers and as a platform for undesirable parasitic reactions; both of these factors will potentially contribute towards first cycle loss when these carbon-containing materials are used as anode materials. Advantageously, the carbon-containing anode materials according to the present invention have a surface oxygen content, measured using X-ray photoelectron spectroscopy (XPS), of from 0 atomic percent (atm.%) to less than 2.5 atm.%, preferably from 0 atm.% to less than 1.5 atm.% and highly preferably from 0 atm.% to less than 1 atm.%. Thus, the treatment of the one or more primary carbon-containing materials with carbonised material, for example derived from the one or more secondary carbon-containing materials in accordance with the present invention, has the effect to reduce the surface oxygen content of the primary carbon-containing material by at least 30 atm.%, preferably by at least 50 atm.% and further preferably at least 90 atm.%. In some embodiments, it is possible to reduce close to 100 atm. % of the surface oxygen atoms.

The specific surface area of a carbon-containing anode material as a whole is also generally regarded to be another useful factor which influences the degree of irreversible capacity of first cycle loss; the higher the specific surface area, the higher the susceptibility of the anode material to over-stabilise the SEI layer thereby increasing the irreversible capacity. In the case of the present invention, however, although treatment of the one or more primary carbon-containing materials with carbonised material, for example derived from the one or more secondary carbon-containing materials, does indeed reduce the specific surface area of the carbon-containing anode material by some 30%, this reduction is not as marked as the reduction in surface micropore surface which can be up to as much as 87%. All the specific surface area values given in the present application have been determined using BET N₂ analysis. FIG. 1 is discussed in detail in the experimental section below to explain a mechanism for how the surface of the carbon-containing anode materials according to the present invention may be able to produce the observed significant reduction in open (surface) micropore surface area whilst at the same time recording a minimal reduction in the overall surface area.

According to the present invention, the one or more primary carbon-containing materials are treated with the one or more secondary carbon-containing materials by contacting one or more primary carbon-containing materials with carbonised material (derived for example from one or more secondary carbon-containing materials) to achieve the desired surface engineered carbon-containing anode material.

Contacting the primary carbon-containing material with the carbonised material may be achieved using any suitable method, such as contacting the primary carbon-containing materials directly with carbonised material or contacting the primary carbon-containing materials with one or more secondary carbon-containing materials and thereafter facilitating the formation of carbonised material from the one or more secondary carbon-containing materials.

Suitably, contacting the primary carbon-containing materials with the one or more secondary carbon-containing materials may involve a solvent-mediated procedure in which solid primary carbon-based material is mixed with one or more solvents and/or other liquids in which the secondary carbon-containing materials are dissolved/dispersed, and then removing the solvent/dispersant prior to the carbonisation of the secondary carbon-containing material. Alternatively, a mechanochemical procedure may be used in which the one or more primary and secondary carbon-containing materials are mixed together (either without a solvent or other dispersant or with an agent to aid mixing), prior to carbonisation of the secondary carbon-containing material. Or further alternatively, using a diffusion-based system in which the one or more primary carbon-containing materials in solid form are contacted with the one or more secondary carbon-containing materials in vapour and/or gaseous form, followed by heating to carbonise the secondary carbon-containing material.

In a second aspect, the present invention provides a process for the preparation of the carbon-containing anode material which is capable of the insertion and extraction of alkali metal ions and which has a carbon structure comprising: contacting a core comprising one or more primary carbon-containing materials in solid form with carbonised material at a temperature of up to 950° C., to thereby yield a carbon-containing anode material that has an open micropore specific surface area of 0 m²/g to 5 m²/g as determined using nitrogen gas BET analysis.

In one embodiment, the outer surface may be engineered to exhibit an open micropore specific surface area of greater than 0 m²/g to 5 m²/g, as determined using nitrogen gas BET analysis.

Ideally, the core does not consist or consist essentially of one or more primary carbon-containing materials selected from graphite and a material that has a fully graphitic structure. In one embodiment, the core may consist essentially of the one or more primary carbon-containing materials, and preferably may consist of the one or more primary carbon-containing materials.

The one or more solid primary carbon-containing materials are preferably in any particulate form (for example granules or powder), as described above. In one embodiment, the particle size distribution of the one or more primary carbon containing materials is from about 1 nm to about 30 µm, as also described above. Suitable primary carbon-containing materials used in the process of the present invention are those described above with reference to the carbon-containing anode material according to the present invention.

The heating conditions will be selected either i) (in the case when the carbonised material is pre-formed prior to contacting with the primary carbon-containing materials) to facilitate the vapour deposition of the carbonised material onto the surface of the primary carbon-containing materials, or ii) to facilitate the carbonisation of the one or more secondary carbon-containing materials which are already on the surface of the primary carbon-containing materials, or iii) to facilitate carbonisation of the one or more secondary carbon-containing materials and subsequent deposition of the resulting carbonised material on the surface of the primary carbon-containing materials.

In each case, the net result will be that a chemical bond such as a covalent bond is formed between the one or more primary carbon-containing materials and the one or more carbonised materials. Therefore, the one or more carbonised materials will be chemically bonded, preferably chemically deposited, on the surface of the one or more primary carbon-containing materials.

Preferably the temperature used is below that which will lead to the over graphitisation of the carbonised material, especially (as discussed above) where the resulting carbon-containing anode material is to be used in a sodium-ion cell. However, it is important that the temperature used according to the process of the present invention will lead to the carbonised material being chemically bonded to the primary carbon containing material.

As described above, the secondary carbon-containing materials from which the carbonised material is preferably derived may therefore comprise a vapour and/or a liquid and/or gaseous phase at, at least one temperature from about 950° C. or less. Preferably, a vapour and/or a liquid and/or a gaseous phase at, at least one temperature between about 200° C. or more to about 950° C. or less.

A maximum temperature of 930° C. is preferred, a maximum temperature of 900° C. is highly preferred and a maximum temperature of 880° C. is particularly preferred. The minimum heating temperature is any which will enable carbonisation to occur and it will depend on the secondary carbon-containing material being used. A minimum temperature of 200° C. will usually be sufficient although a lower temperature may also be possible if a catalyst or other reagent is used to reduce the activation energy needed to thermo-catalytically decompose and carbonise the secondary carbon-containing material. Possible catalysts include small amounts of one or more of metallic compounds or metal oxide compounds, such as transition metals or transition metal oxides.

As described above, suitable secondary carbon-containing materials from which the carbonised material is preferably derived, may be selected from one or more organic and/or hydrocarbon materials, for example alkanes, alkenes, alkynes or arenes, which may be straight chained, branched or cyclic. The secondary carbon-containing materials themselves may be derived from coal- or petroleum-based tar or pitch, oil or plant-based materials. Secondary carbon-containing materials which comprise one or more gaseous hydrocarbons with the general formula: CₙH₂ₙ₊₂ where 1 ≤ n ≤ 10, are particularly preferred.

In a preferred process of the present invention, the total pressure, total flow rate as well as the individual partial pressures and individual flow rates of reagents, when the primary carbon-containing materials are contacted with fluid (liquid, vapour or gaseous) secondary carbon-containing materials or fluid (liquid, vapour or gaseous) pre-formed carbonised material, are optimised to ensure the correct amount of carbonised material is deposited on the primary carbon-containing materials. Preferred total pressure, total flow rate and individual partial pressure and individual flow rate of the secondary carbon-containing material are in the range of 10⁻⁶ to 3×10⁷ Pa, 0.001 to 1000 L/min, 10⁻⁶ to 3×10⁷ Pa and 0.001 to 1000 L/min respectively and further preferably in the range of 10⁴ to 10⁶ Pa, 0.01 to 100 L/min, 10⁴ to 10⁶ Pa and 0.01 to 100 L/min and highly preferably in the range 5×10⁴ to 5×10⁵ Pa, 0.1 to 10 L/min, 5×10⁴ to 5×10⁵ Pa and 0.1 to 10 L/min respectively.

Injection carbon vapour deposition (CVD) systems and aerosol-assisted reactors are examples of setups in which pressure and flow rates of individual fluid precursors could be controlled.

In a further preferred process of the present invention, the concentration of carbonised material and/or the concentration of the one or more secondary carbon-containing materials used to contact with the one or more primary carbon-containing materials, is preferably in the range as 0.001 - 100 vol.%, preferably 0.01 - 10 vol.%, further preferably 0.01 to 5 vol% and highly preferably 0.05 - 0.1 vol.% in a carrier gas for gaseous secondary carbon-containing materials, and in the range as 0.001 - 100 vol.% for in a solvent or carrier liquid for liquid and semi solid (e.g. pitch, tar, oil) secondary carbon-containing materials.

In a still further preferred process of the present invention, the duration of the heating step (annealing time) is also preferably tuned to i) minimise, and preferably prevent, over graphitisation of the carbonised material; the longer the heating time, the more the carbonised material is likely to be over graphitised. And ii) to ensure that it is long enough to chemically deposit enough carbonised material to plug at least a portion of the open micropores, as discussed above.

As described above, the process of present invention is not limited to the use of chemical vapour deposition. Indeed, the skilled person would be aware of alternative methods to chemically bond materials to a primary substrate and these are encompassed within the scope of the present invention. Example of these may include plasma-enhanced deposition, atomic-layer deposition and physical vapour deposition.

An annealing time of 5 minutes to 120 minutes is preferred, and an annealing time of 30 minutes to 90 minutes is especially preferred. The annealing time is the period required for the carbonised material to be deposited on the primary carbon-containing materials.

In a particularly preferred process of the present invention, the step of contacting the one or more primary carbon-containing materials in solid form with carbonised material is conducted using any means needed to ensure that at least a portion of the surface of each of the particles of the primary carbon-containing material contacts the carbonised material. Suitable means include: stirring or agitating the primary carbon-containing materials when contacting with the carbonised material, spraying the particles of primary carbon-containing materials into an atmosphere comprising vaporised carbonised material, and spreading the primary carbon-containing material over a flat plate or wide mouthed reaction vessel before introducing the carbonised material.

Further still, in a particularly preferred process of the present invention, it is desirable that the step of contacting the one or more primary carbon-containing materials in solid form with carbonised material is performed in the final stage of the process of the present invention. More particularly, it is highly desirable that this step is performed after any abrasive treatment (e.g. milling, griding, crushing or the like) to the one or more primary carbon-containing materials. This advantageously avoids the outer surface comprising the one or more carbonised materials chemically bonded on the one or more primary carbon-containing materials being disturbed. For instance, post surface treatment that comprises abrasive treatment could crack open the passivated surface and expose the micropores.

For the avoidance of any doubt, post surface treatments steps such as mixing the active material with binder, electrode printing (e.g. coating) and electrode calendaring (e.g. rolling), are not considered as “abrasive treatment” within the meaning of this phrase.

The carbon-containing anode material according to the present invention is suitable for use as an electrode active material in secondary battery applications, especially in alkali metal-ion cells, and particularly in sodium-ion cells.

In a third aspect, the present invention provides an alkali metal-ion cell comprising at least one negative electrode (an anode) as described above. Preferably, that has an open micropore specific surface area of from greater than 0 m²/g to 5 m²/g determined using nitrogen gas BET analysis,

The alkali metal-ion cell will also comprise a positive electrode (a cathode) which preferably comprises one or more positive electrode active materials which are capable of inserting and extracting alkali metals, and which are preferably selected from oxide-based materials, polyanionic materials, and Prussian Blue Analogue-based materials. Particularly preferably, the one or more positive electrode active materials comprise one or more selected from alkali metal-containing oxide-based materials and alkali metal-containing polyanionic materials, in which the alkali metal is one or more alkali metals selected from sodium and/or potassium, and optionally in conjunction with lithium. Certain positive electrode active materials contain lithium as a minor alkali metal constituent, i.e. the amount of lithium is less 50% by weight, preferably less than 10% by weight, and ideally less than 5% by weight, of the total alkali metal content,

The most preferred positive electrode active material is a compound of the general formula:

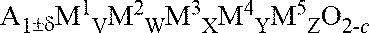

wherein
A is one or more alkali metals selected from sodium, potassium and lithium;
M¹ comprises one or more redox active metals in oxidation state +2,
M² comprises a metal in oxidation state greater than 0 to less than or equal to +4;
M³ comprises a metal in oxidation state +2;
M⁴ comprises a metal in oxidation state greater than 0 to less than or equal to +4;
M⁵ comprises a metal in oxidation state +3;
wherein
0 ≤ δ ≤ 1;
V is > 0;
W is ≥ 0;
X is ≥ 0;
Y is ≥ 0;
at least one of W and Y is > 0
Z is ≥ 0;
C is in the range 0 ≤ c < 2
wherein V, W, X, Y, Z and C are chosen to maintain electrochemical neutrality.

For the avoidance of doubt, the term “one or more alkali metals selected from sodium, potassium and lithium” is to be interpreted to include: Na, K, Li, Na+K, Na+Li, K+Li, and Na+K+Li.

Ideally, metal M² comprises one or more transition metals, and is preferably selected from manganese, titanium and zirconium; M³ is preferably one or more selected from magnesium, calcium, copper, tin, zinc and cobalt; M⁴ comprises one or more transition metals, preferably selected from manganese, titanium and zirconium; and M⁵ is preferably one or more selected from aluminium, iron, cobalt, tin, molybdenum, chromium, vanadium, scandium and yttrium. A cathode active material with any crystalline structure may be used, and preferably the structure will be 03 or P2 or a derivative thereof, but, specifically, it is also possible that the cathode material will comprise a mixture of phases, i.e. it will have a non-uniform structure composed of several different crystalline forms.

Highly preferred positive electrode active materials comprise sodium and/or potassium-containing transition metal-containing compounds, with sodium transition metal nickelate compounds being especially preferred. Particularly favourable examples include alkali metal-layered oxides, single and mixed phase 03, P2 and P3 alkali metal-layered oxides, alkali metal-containing polyanion materials, oxymetallates Prussion blue analogs and Prussioan white analogs. Specific examples include O3/P2-A_{0.833}Ni_{0.317}Mn_{0.467}Mg_{0.1}Ti_{0.117}O₂, 03-A_{0.95}Ni_{0.3167}Mn_{0.3167}Mg_{0.1583}T1_{0.2083}O₂ , P2-type A_{⅔}Ni_{⅓}Mn_{½}Ti_{⅙}O₂, P2-A_{⅔}(Fe_{½}Mn_{½})O₂, P′2-A_{⅔}MnO₂, P3 or P2-A_{0.67}Mn_{0.67}Ni_{0.33}O₂, A₃V₂(PO₄)₃, AVPO₄F, AVPO₄F, A₃V₂(PO₄)₃ A₃V₂(PO₄)₂F₃, A₃V₂(PO₄)₂F₃, AₓFe_{y}Mn_{y}(CN)₆.nH₂O (0 ≤ x,y,z ≤ 2; 0 ≤ n ≤ 10), 03, P2 and/or P3- AₓMn_{y}Ni_{z}O₂ (0 ≤ x ≤ 1 and 0 ≤ y,z ≤ 1). A₂Fe₂(SO₄)₃, A₂Ni₂SbO₆ and A₃Ni₂SbO₆, where “A” is these compounds is one or more alkali metals selected from Li, Na and K, is preferably Na and/or K, and is most preferably Na.

Advantageously, the alkali metal-ion cells according to the present invention may use an electrolyte in any form, i.e. solid, liquid or gel composition may be used, and suitable examples include; 1) liquid electrolytes such as >0 to 10 molar alkali metal salt such as NaPF₆, NaBF₄, sodium bis(oxalate) (NaBOB), sodium triflate (NaOTf), LiPF₆, LiAsF₆. LiBF₄, LiBOB, LiCIO₄, LiFSi, LiTFSi, Li-triflate and mixtures thereof, in one or more solvents selected from ethylene carbonate (EC), diethyl carbonate (DEC), propylene carbonate (PC), (preferably as a mixture EC:DEC:PC in the ratio 1:2:1 wt./wt.), gamma butyrolactone (GBL) sulfolane, diglyme, triglyme, tetraglyme, dimethyl sulfoxide (DMSO), dioxolane, and mixtures thereof, all with/without diluents such as HFE (1,1,2,2-Tetrafluoroethyl 2,2,3,3-tetrafluoropropyl ether) or D2 (1,1,2,2-Tetrafluoroethyl 2,2,2-trifluoroethyl ether)). 2) gel electrolytes based on either one of the following matrix materials used singularly or in conjunction with each other; or 3) solid electrolytes such as NASICON-type such as Na₃Zr₂Si₂PO₁₂, sulphide-based such as Na₃PS₄ or Na₃SbS₄, hydride-based such as Na₂B₁₀H₁₀-Na₂B₁₂H₁₂ or β-alumina based such as Na₂O.(8-11)Al₂O₃ or the related β″-alumina based such as Na₂O.(5-7)Al₂O₃). Known electrolyte additives such as 1,3-propanediolcyclic sulfate (PCS), P123 surfactant, Tris(trimethylsilyl) Phosphite (TMSP), Tris(trimethylsilyl) borate (TMSB), 1-Propene 1,3 Sultone, 1,3- Propanesultone, may also be included in the electrolyte, as can binders such as polyvinylidenefluoride (PVDF), polyvinylidenefluoride- hexafluoropropylene (PVDF-HFP), poly(methylmethacrylate) (PMMA), sodium carboxymethyl cellulose (CMC) and Styrene-Butadiene Rubber (SBR).

It is to be noted that as well as being excellent anode materials, the surface engineered carbon-containing materials of the present invention also provide additional commercial advantages.

The first of these concerns an improved moisture sensitivity. Due to their extremely low level of open microporosity, the surface-engineered carbon-containing anode materials of the present invention adsorb significantly less atmospheric moisture upon exposure than non-surface engineered primary carbon-containing materials. This not only makes handling the applicant’s anode material easier during anode fabrication, but it also reduces the moisture content of the resulting anode coatings and finished cells.

The second unexpected advantage concerns an improvement in the viscosity of an electrode slurry which contains the carbon-containing anode material according to the present invention. During cell manufacture, the viscosity of the electrode slurries should not be overlooked as this will make an important difference to the smooth running of the process and the quality control of the resulting electrode. Electrode materials (active, binder and additives) are typically mixed and dispersed in an organic or aqueous solvent so that they can be coated on the current collector. In the coating process, the solvent evaporates and leaves the dry components behind. Insufficient viscosity results in a slurry which is too runny, and this can lead to misaligned coating edges; an excessively viscose slurry meanwhile will pose process issues because the slurry will not run as smoothly as it should. This adversely affects the quality of dry coating. Typically, electrode materials with reduced surface area require less solvent to achieve a given optimum viscosity. This is advantageous from cost point of view. Thus, as a result of their lower micropore surface area, the surface-engineered carbon-containing anode materials according to the present invention exhibit a lower viscosity for the same solid content, and this yields a smoother surface morphology and purer surface chemistry. Cost savings can be made by using less solvent to achieve a good quality electrode.

As demonstrated in the specific examples discussed below, the advantageous electrochemical performance improvements can be achieved using the carbon-containing anode materials according to the present invention can be summarised as follows. i) The irreversible capacity and first cycle loss of Na-ion full cells featuring the carbon-containing materials is as low as 25.2 mAh/g and 8.6% respectively. This is a significant reduction compared with the values, 54.9 mAh/g and 16.8% respectively obtained from benchmark cells featuring conventional hard carbon anodes and otherwise identical chemistry and components; ii) Na-ion full cells featuring the carbon-containing anode materials of the present invention exhibit significantly improved capacity retention and cycling stabilities at faster charge and discharge rates up to ± 3C; iii) The carbon-containing anode materials according to the present invention have a reduced moisture adsorption rate and Na-ion full cells featuring these carbon-containing anode materials have improved cycling stabilities due to their reduced overall moisture content.

### BRIEF DESCRIPTION OF THE DRAWINGS

The present invention will now be described with reference to the following figures in which:

FIG. 1 shows a schematic representation of a grain of pristine primary carbon-containing material and a grain of surface engineered carbon-containing anode material according to the present invention.

FIG. 2 shows a flow chart to illustrate a preferred process of the present invention.

FIG. 3 is a bar chart which illustrates the amount of surface oxygen (atm. %) present on pristine hard carbon-containing materials compared with the same hard carbon-containing materials treated with carbonised material in accordance with the present invention.

FIG. 4 is a bar chart which illustrates the BET specific surface area (m²/g) of pristine hard carbon-containing materials compared with and the same hard carbon-containing materials treated with carbonised material in accordance with the present invention.

FIG. 5 is a bar chart which illustrates the BET micropore surface area (m²/g) of pristine hard carbon-containing materials compared with and the same hard carbon-containing materials treated with carbonised material in accordance with the present invention.

FIG. 6 shows a representative T-plot for sample material 8 according to the present invention.

FIG. 7 shows voltage vs. Na⁺/Na-capacity curves obtained for Na-ion half cells which use a carbon-containing anode material 3 according to the present invention.

FIG. 8 shows voltage vs. Na⁺/Na-capacity curves obtained for Na-ion half cells which use a carbon-containing anode material 8 according to the present invention.

FIG. 9 shows voltage vs. Na⁺/Na-capacity curves obtained for Na-ion half cells which use a carbon-containing anode material 4 (control).

FIG. 10 shows voltage vs. capacity curve obtained for a three-electrode full cell which uses a carbon-containing anode material 7 according to the present invention.

FIG. 11 shows voltage vs. capacity curve obtained for a three-electrode full cell which uses a carbon-containing anode material 8 according to the present invention.

FIG. 12 shows voltage vs. capacity curve obtained for a three-electrode full cell which uses a carbon-containing anode material 6 according to the present invention.

FIG. 13 illustrates the cathode specific capacity, cycle-life performance and coulombic efficiency of a full sodium-ion cell which includes a carbon-containing anode material 8 at fast discharge.

FIG. 14 illustrates the cathode specific capacity, cycle-life performance and coulombic efficiency of a full sodium-ion cell which includes a carbon-containing anode material 8 at fast discharge.

FIG. 15 illustrates the cathode specific capacity, cycle-life performance and coulombic efficiency of a full sodium-ion cell which includes a carbon-containing anode material 6 and 8 at fast discharge.

FIG. 16 illustrates the cathode specific capacity of a full sodium-ion cell comprising the carbon-containing anode material 8 at fast charge.

FIG. 17 shows a graph of moisture content vs. air exposure time to illustrate the reduced sensitivity to moisture exhibited by the carbon-containing anode materials of materials 6, 7, 8, 9 and 10 made according to the present invention compared against material 4 (control).

FIG. 18 is a bar graph to illustrate the sensitivity to moisture of electrodes made using the carbon-containing anode materials 7, 8 and 10 made according to the present invention compared with material 4 (control).

FIG. 19 shows various particle size distributions obtained using laser diffraction of primary hard carbon containing materials.

FIG. 20 shows Scanning Electron Microscopy images of primary hard carbon containing materials.

### DETAILED DESCRIPTION

### Proposed Model for the Structure of the Carbon-Containing Anode Materials According to the Present Invention

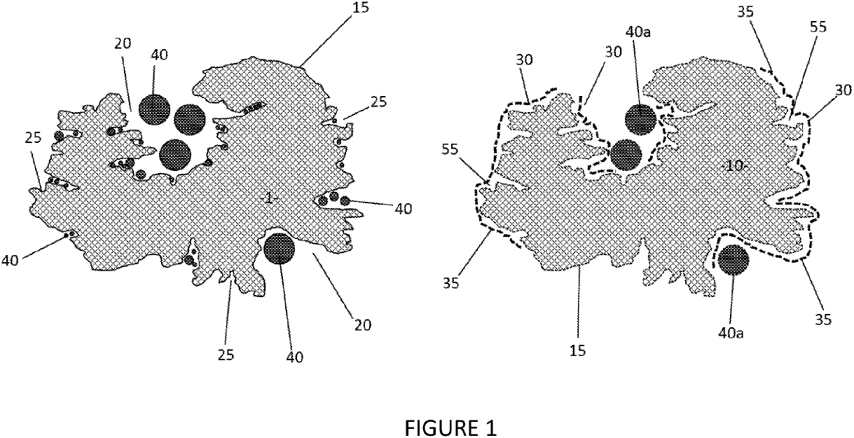

FIG. 1 shows a schematic representation of a grain of pristine carbon-containing material comprising a core comprising primary carbon-containing material 1. FIG. 1 further shows a schematic representation of a grain of surface engineered carbon-containing anode material 10 (i.e. non-pristine) according the present invention comprising a core comprising primary carbon-containing material 1 and an outer surface 15 comprising carbonised material 35 chemically bonded on the primary carbon-containing material 1. More particularly, FIG. 1 provides assistance to explain a proposed mechanism for how it may be possible for the surface engineered carbon-containing anode materials according to the present invention 10 to exhibit a significantly reduced open micropore surface area, whilst at the same time recording a minimal reduction in the overall surface area. FIG. 1 may also assist to explain how the surface engineered carbon-containing anode material according to the present invention 10 has a greater resistance to moisture adsorption compared with the pristine carbon-containing material comprising a core comprising primary carbon-containing material 1.

A representative grain of pristine carbon-containing material comprising a core comprising primary carbon-containing material 1 with open porosity, as depicted in FIG. 1, has an irregular and uneven outer surface 15 formed with a plurality of open mesopores 20, and a plurality of open micropores 25. Following the treatment of the pristine carbon-containing material comprising a core comprising primary carbon-containing material 1, for example in accordance with the method of the present invention, a non-uniform, incomplete and extremely thin layer 30 of particles of carbonised material 35 (for example derived from secondary carbon-containing material) is deposited on the outer surface 15 of the pristine carbon-containing material comprising a core comprising primary carbon-containing material 1 to produce surface engineered carbon-containing anode material 10 according to the present invention.

As shown in FIG. 1, the entrance to many of the open micropores 25 is blocked by the deposited particles of carbonised material 35 that form the extremely thin layer 30. Blocked micropores are indicated as 55 on the surface engineered carbon-containing anode material 10 in FIG. 1. It is understood that the extreme thinness of the non-uniform, incomplete layer 30 will make it highly unlikely to be sufficient to cover over/block the entrance to the larger mesopores 20, but the layer 30 may instead partially coat the inside of the mesopore which may reduce the surface area of these pores, but only slightly.

Increased hydrophobicity of the surface engineered carbon-containing anode materials according to the present invention can also be explained by the fact that a reduced number of water molecules 40a are able to enter the plugged or blocked micropores 55, compared with the number of water molecules 40 that are able to enter the open micropores 25 in the pristine primary carbon-containing material 1, thereby making the surface engineered carbon-containing material according to the present invention 10 more resistant to moisture than non-surface engineered material. This is investigated below.

### General Method for Preparing the Carbon-Containing Anode Materials According to the Present Invention

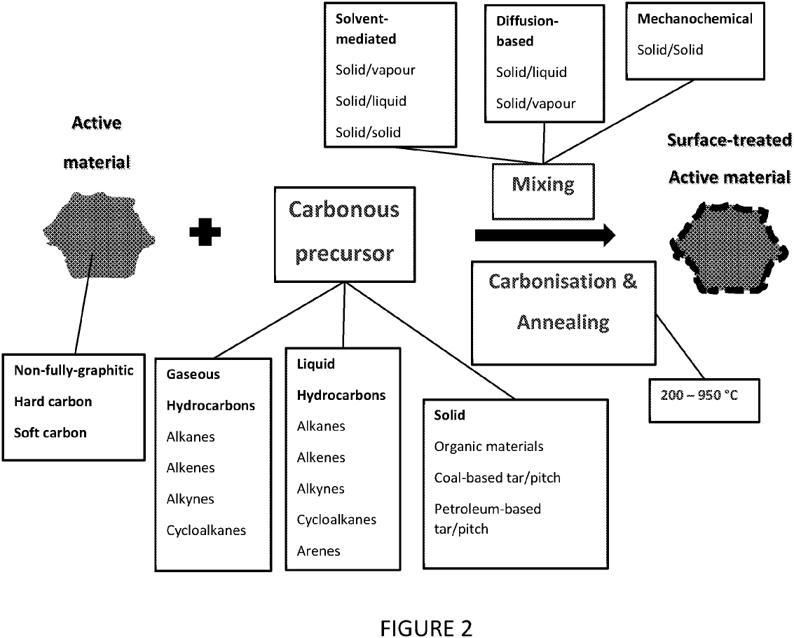

FIG. 2 provides a schematic flow chart to illustrate the general process according to the present invention. In a typical process, one or more primary carbon-containing materials in particulate form are treated at 200 to 950° C. for 30-120 min with a carbonised material, which, as discussed above, may either be a pre-prepared carbonised material, or it may be a carbonised material derived from one or more secondary carbon-containing materials. Ideally, the treatment process is conducted in an inert gas atmosphere. Further ideally, the one or more secondary carbon-containing materials are provided at the required concentration (as discussed above), and gaseous secondary carbon-containing material are preferably provided in a carrier gas (preferably an inert carrier gas), and liquid secondary carbon-containing material are preferably provided in a carrier solvent or other carrier liquid.

Details of carbon-containing anode materials which were tested are given in Table 1 below:

TABLE 1

| Experimental material | Primary carbon containing material | Inert gas and Secondary carbon-containing material (Alkane of the formula CₙH₂ₙ₊₂ where 1 ≤ n ≤ 10) | Treatment Conditions |
|---|---|---|---|
| 1 (control) (Pristine hard carbon 1) | Hard carbon 1 | NONE | NONE |
| 2 (control) | Hard carbon 1 | 100% Argon (no secondary carbon-containing material) | 360 min >1000° C. |
| 3 | Hard carbon 1 | Argon containing 0.06 vol.% alkane | 30 min 780° C. |
| 4 (control) (Pristine hard carbon 2) | Hard carbon 2 | NONE | NONE |
| 5 (control) | Hard carbon 2 | 100% Argon (no secondary carbon-containing material) | 360 min >1000° C. |
| 6 | Hard carbon 2 | Argon containing 0.06 vol.% alkane | 30 min 830° C. |
| 7 | Hard carbon 2 | Argon containing 0.06 vol.% alkane | 90 min 780° C. |
| 8 | Hard carbon 2 | Argon containing 0.06 vol.% alkane | 30 min 780° C. |
| 9 | Hard carbon 2 + conductive carbon additive (46:1 wt. ratio) | Argon containing 0.06 vol.% alkane | 30 min 830° C. |
| 10 | Hard carbon 2 | Argon containing 0.06 vol.% alkane | 30 min 880° C. |
| 11 | Hard carbon 2 | Argon containing 0.06 vol.% alkane | 30 min 930° C. |
| 12 (control) | Hard carbon 3 | NONE | NONE |
| 13 (control) | Hard carbon 3 | 100% Argon (no secondary carbon-containing material) | 360 min >1000° C. |
| 14 | Hard carbon 3 | Argon containing 0.06 vol.% alkane | 30 min 780° C. |

### Measurement of Size of Primary Carbon Containing Material

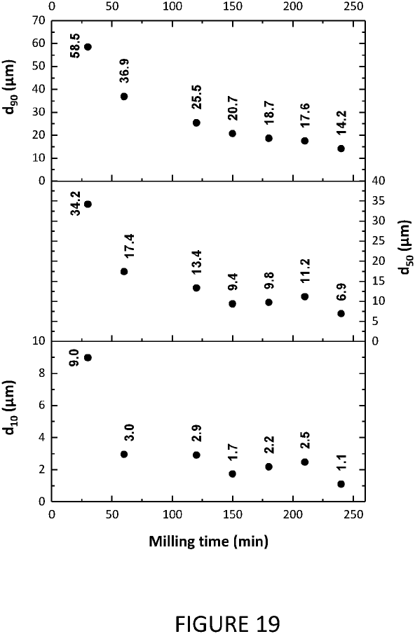

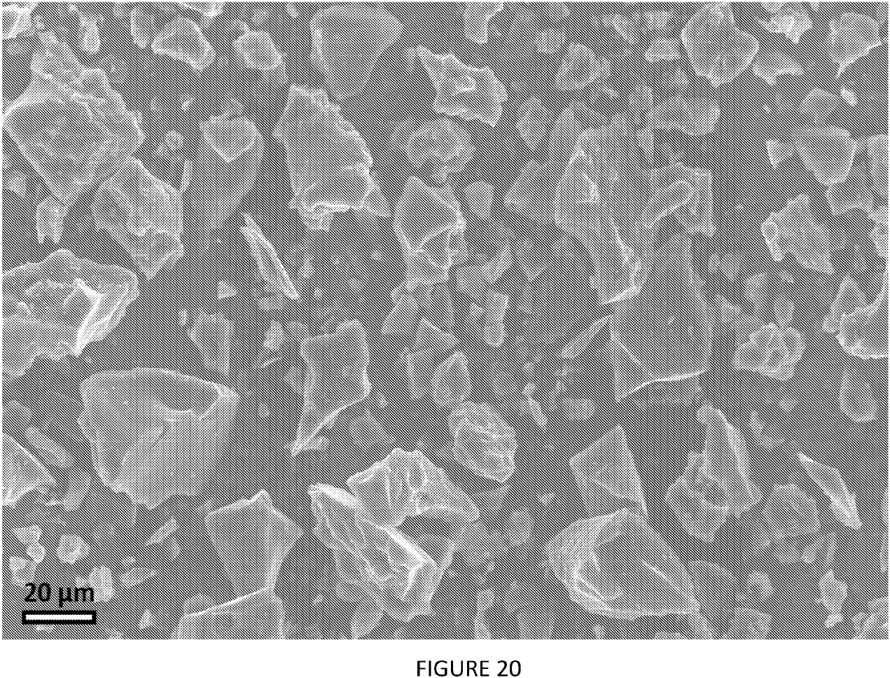

Size measurement of the primary hard carbon containing material was carried out using laser diffraction and Scanning Electron Microscopy. The results obtained are shown in FIGS. 19 and 20, respectively. The results indicate the following preferred particle size distribution of the primary carbon containing materials:

| Parameter | Preferred lower end point | Preferred upper end point |
|---|---|---|
| D10 [µm] | 0.01 | 4 |
| D50 [µm] | 4 | 15 |
| D90 [µm | 15 | 30 |

When the one or more primary carbon-containing materials comprise one or more carbon composite materials represented by: (carbon)-X, as disclosed herein, the particle size distribution may, in some instances, be different to those indicated above. This is because the size of some of the composite materials may be in the nanoscale range. Therefore, in one embodiment, a particle size distribution of the primary carbon containing materials of the present invention is from about 1 nm to about 30 µm , preferably from about 1 nm to about 20 µm.

To the best of the Applicant’s knowledge, the surface treatment of the present invention does not substantially alter the particle size distribution of the primary carbon containing material. In one example of the present invention, the mass deposit of the secondary carbon containing material was found to be very small (2.2 ± 0.8 wt.% per 30 min of deposition). Therefore, the particle size distribution of the primary carbon containing material, post surface treatment, can be considered as being essentially the same as the particle size distribution of the primary carbon containing material, pre surface treatment.

### Measurement of Graphitisation Characteristics of the Carbon-Containing Anode Materials According to the Present Invention

As discussed above, it is important to control the level of graphitisation of the carbonised material deposited on the outer surface of the primary carbon-containing materials, to match the requirements of the cell chemistry in which the anode materials are used. Table 3 below compares the graphitisation characteristics (graphitic spacing distance and size of crystallites in the stacking (Lc) and in-plane (La) directions) of surface engineered carbon-containing anode materials according to the present invention against the graphitisation characteristics of the non-surface engineered primary carbon-containing materials (i.e. the starting material used to make the primary carbon-containing materials).

As can be seen from the results in Table 3, the presence of surface engineering according to the present invention has no significant effect on the degree of graphitisation, consequently, the anode materials 3, 6-11 and 14 are expected to be highly suitable for use in a sodium-ion cell.

### Measurement of Surface Oxygen Content (atm.%)

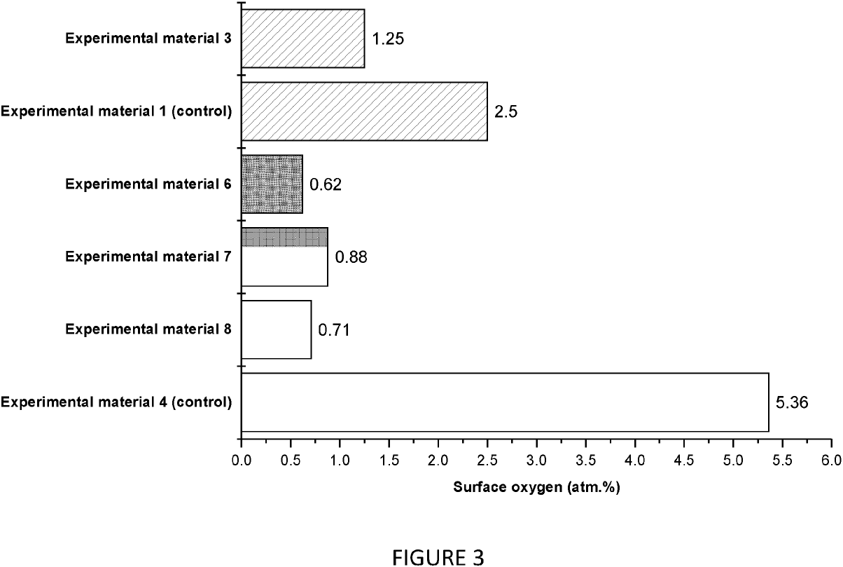

The amount of oxygen present on the surface of i) the carbon-containing anode materials according to the present invention and ii) the primary carbon-containing materials prior to contact with carbonised material was measured using XPS with analysis specifications summarised in Table 2 below. The surface oxygen content results are shown in FIG. 3.

TABLE 2

| Instrument make/model | Kratos Axis Supra |
|---|---|
| X-ray source | Al |
| X-ray source energy | 1486.7 eV |
| X-ray source strength | 150 W |
| X-ray source spot size | 700 µm × 300 µm |
| Analysis spot size | 700 µm × 300 µm |
| Charge control | Electronic charge neutralization using magnetic immersion lens. Filament current = 0.27 A, charge balance = 3.3 V, filament bias = 3.8 V. |
| Analysis pressure | < 10⁻⁸ Torr/PSI |
| Analyser type | Spherical sector |
| Detector | Multichannel resistive plate |
| Number of detector elements | 3 MCP, 128 channel DLD |
| Temperature during analysis | 294 K |
| Survey spectra pass energy | 160 |
| Region spectra pass energy | 20 |
| Mounting/ex-situ preparation | Samples were mounted onto copper tape inside a front mounted glovebox filled with N₂ |
| In-situ preparation | N/A |
| Elements analysed | C, O, Si |
| Auger regions analysed | N/A |
| Samples analysed | 8 |

### Measurement of Bet Surface Area (m²/g)

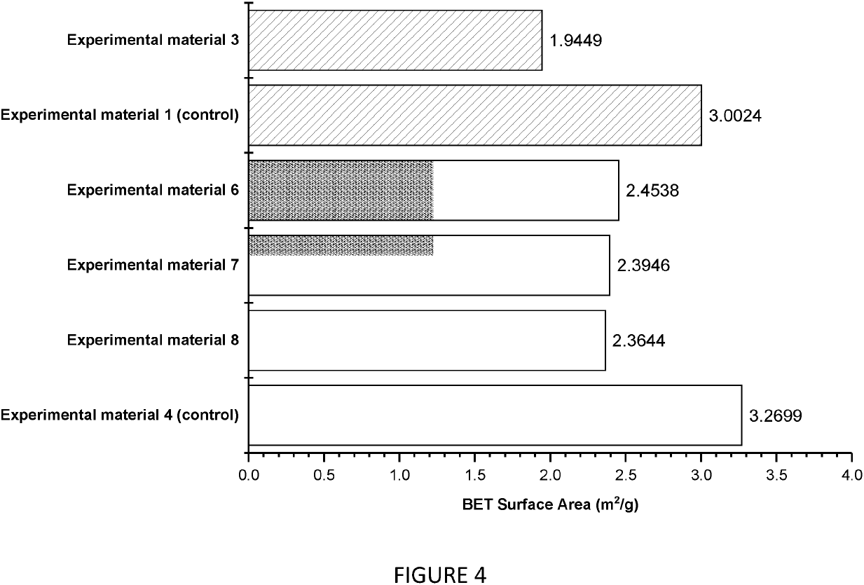

BET analysis was carried out using a Micromeritics Gemini VII 2390 surface area analyser using Nitrogen as the adsorbate at liquid nitrogen temperature. All samples were degassed at 250° C. under flowing nitrogen overnight prior to analysis. The results obtained are shown in FIG. 4.

### Measurement of Bet Micropore Surface Area (m²/g)

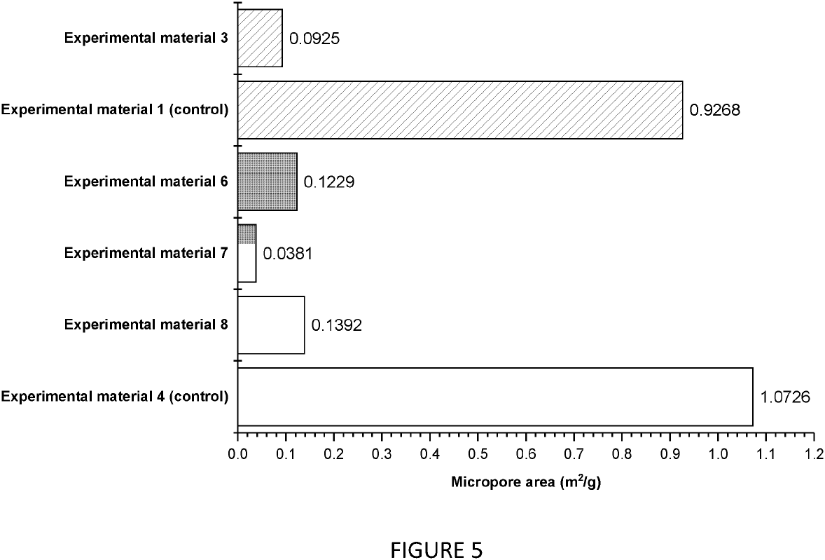

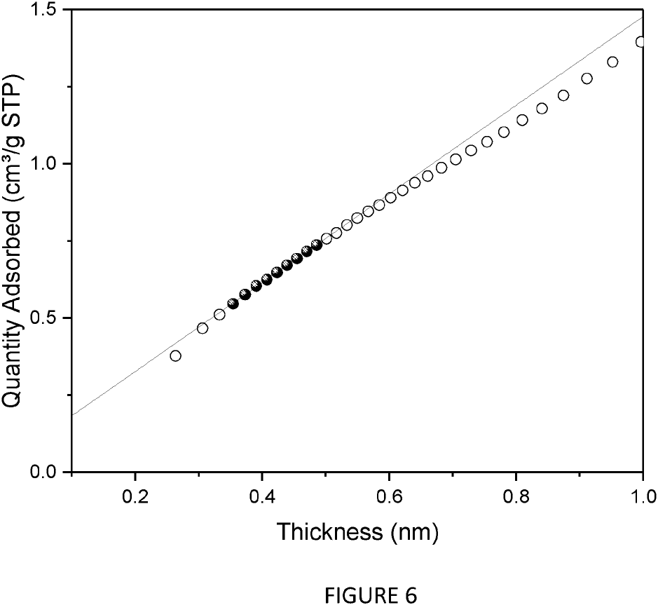

From the volume of gas adsorbed by the materials, it is possible - by applying models - to estimate the surface area of micropores accessible to the gas (the open micropores, aka the micropores at the surface of the carbon-containing anode material), calculated per gram of the carbon-containing anode material (or pristine hard carbon-containing material in the case of the control samples). This was achieved from ‘t-Plot’ analysis. A typical t-Plot consists of the quantity of gas adsorbed at standard temperature and pressure vs. Harkins and Jura statistical thickness (nm)) according to the Harkins and Jura thickness equation (t = [ 13.99 / ( 0.034 - log(p/p°) ) ] ^ 0.5). The difference between the external surface area and the BET (total) surface area is the estimated micropore surface area. The results obtained are shown in FIG. 5. A representative t-Plot for material 8 is shown in FIG. 6.

### Measurement of Moisture Content (ppm)

The moisture content of active materials and the anode electrodes (coatings) were measured using a Moisture Meter (Coulometric Titration) Model CA-200, from MITSUBISHI CHEMICAL ANALYTECH titrator without any exposure (0 min) and after 30 and 60 min of exposure to atmosphere with 20-50% relative humidity.

### Results

Table 3 below summarises the graphitisation characteristics, surface oxygen content, BET surface area, micropore surface area and moisture content results obtained as described above.

TABLE 3

| Experimental Material | Spacing (nm) | Lc(nm) | La(nm) | Surface Oxygen content Atm.% | BET Surface Area (m²) | Micropore Surface Area | Moisture Content (ppm) | | |
|---|---|---|---|---|---|---|---|---|---|
| | | | | | | | 0 Min | 30 Min | 60 Min |
| 1 (control) | 0.380 | 1.954 | 7.081 | 2.5 | 3.002 | 0.927 | - | - | - |
| 2 (control) | - | - | - | - | - | - | - | - | - |
| 3 | 0.383 | 1.888 | 6.630 | 1.25 | 1.945 | 0.092 | - | - | - |
| 4 (control) | 0.383 | 2.008 | 6.504 | 5.36 | 3.270 | 1.073 | 57.100 | 235.667 | 312.806 |
| 5 (control) | - | - | - | - | - | - | - | - | - |
| 6 | 0.386 | 1.935 | 5.671 | 0.62 | 2.454 | 0.123 | 10.736 | 9.264 | 12.812 |
| 7 | - | - | - | 0.88 | 2.395 | 0.038 | 13.252 | 21.091 | 14.298 |
| 8 | - | - | - | 0.71 | 2.364 | 0.139 | 42.992 | 44.892 | 30.611 |
| 9 | - | - | - | - | - | - | 7.954 | - | - |
| 10 | - | - | - | - | - | - | 9.423 | 8.135 | 6.262 |
| 11 | - | - | - | - | - | - | 13.721 | 19.544 | 58.402 |
| 12 (control) | 0.392 | 1.880 | 6.244 | 17.29 | 19.280 | 11.604 | - | - | - |
| 13 (control) | - | - | - | - | - | - | - | - | - |
| 14 | 0.389 | 1.841 | 6.007 | 0.58 | 4.149 | - | - | - | - |

### Product Analysis Using XRD

Analysis by X-ray diffraction techniques is conducted using a Siemens (RTM) D5000 powder diffractometer to confirm that the desired target materials had been prepared, to establish the phase purity of the product material and to determine the types of impurities present. From this information it is possible to determine the lattice parameters of the unit cells.

The general XRD operating conditions used to analyse the materials are as follows:
Slits size: 1 mm
Range: 2θ = 10 ° - 60 °
X-ray Wavelength = 1.5418 Å (Angstroms) (Cu Kα)
Speed: 1.0 seconds/step
Increment: 0.025 °

### Electrochemical Results

Anodes comprising carbon-containing materials made according to the present invention are prepared by solvent-casting a slurry comprising an experimental carbon-containing material (as described above), binder and solvent, in a weight ratio 92:6:2. A conductive carbon such as C65™ carbon (Timcal) (RTM) may be included in the slurry. PVdF and Styrene-Butadiene Rubber/Carboxymethylcellulose (SBR/CMC) are suitable binders, and N-Methyl-2-pyrrolidone (NMP) or water may be employed as the solvent. The slurry is then cast onto a current collector foil (e.g. pristine or carbon-coated aluminium foil) and heated until most of the solvent evaporates and an electrode film is formed. The anode electrode is then dried further under dynamic vacuum at about 120° C. and calendered to the desired thickness.

### Cell Testing

For half-cell tests, experimental carbon-containing anode electrodes are paired with one disk of sodium metal as reference and counter electrode. Glass Fibre GF/A is used as the separator and a suitable electrolyte is also employed. Any suitable Na-ion electrolyte may be used, preferably this may comprise one or more salts, for example NaPF6, NaAsF6, NaClO4, NaBF4, NaSCN and Na triflate, in combination with one or more organic solvents, for example, EC, PC, DEC, DMC, EMC, glymes, esters, acetates etc. Further additives such as vinylene carbonate and fluoro ethylene carbonate may also be incorporated. A preferred electrolyte composition comprises 0.5 M NaPF6/EC:PC:DEC.

All cells were rested for 24h prior to cycling. For three-electrode tests, carbon-containing anode material according to the present invention is used as negative electrode, a standard oxide material is used as positive electrode and a piece of sodium is used as reference, all three electrodes are wet by the same electrolyte. As separator, two polyethylene membranes of 24.5 um thickness were used.

The half-cells are tested using Constant Current cycling technique, and the three electrode cells are tested using Constant Current - Constant Voltage technique.

The cell is cycled at a given current density between pre-set voltage limits. A commercial battery cycler from MTI Inc. (Richmond, CA, USA) or Maccor (Tulsa, OK, USA) was used. On charge, alkali ions are inserted into the carbon-containing anode material. During discharge, alkali ions are extracted from the anode and re-inserted into the cathode active material.

### Results

### Electrochemical Testing of Experimental Carbon-Containing Anode Material 3 - Half Cell (vs. Na⁺/Na)

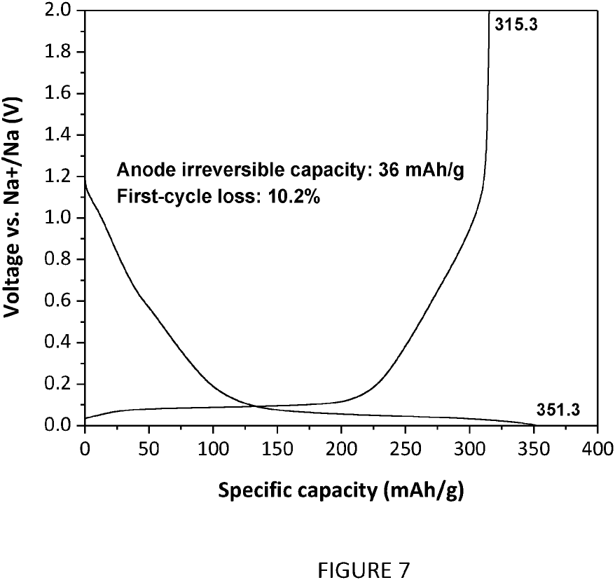

FIG. 7 shows the anode sodiation and desodiation potential curves as functions of anode specific capacity. Using the experimental carbon-containing anode material 3 according to the present invention as an example, it is possible to achieve a reversible desodiation capacity of 315 mAh/g with an irreversible specific capacity of 36.0 mAh and 89.8% first-cycle columbic efficiency.

### Electrochemical Testing of Experimental Carbon-Containing Anode Material 8 - Half Cell (vs. Na⁺/Na)

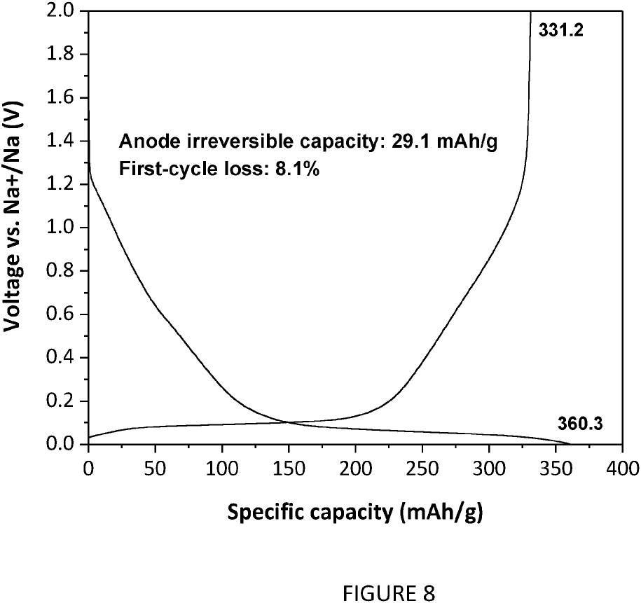

FIG. 8 shows the anode sodiation and desodiation potential curves as functions of anode specific capacity. Using the experimental carbon-containing anode material 8 according to the present invention as an example, it is possible to achieve a reversible specific capacity of more than 330 mAh/g with an irreversible specific capacity of 29.1 mAh and 91.9% first-cycle columbic efficiency.

### Electrochemical Testing of Control Anode Material 4 (Control) - Half Cell (vs. Na⁺/Na)

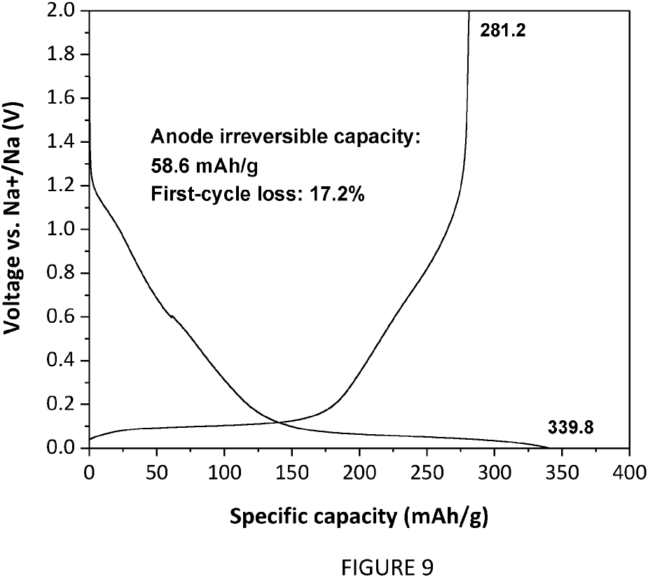

FIG. 9 shows the anode sodiation and desodiation potential curves as functions of anode specific capacity. Using the control anode material 4 according to the present invention as an example, reversible specific capacity of 281 mAh/g with an irreversible specific capacity of 58.6 mAh and 82.8% first-cycle columbic efficiency were obtained. Comparing these values to those of the experimental carbon-containing anode material 8 (FIG. 7 vs. FIG. 8), it is obvious that the surface treatment according to the present invention results in a significantly improved electrochemical performance.

### Electrochemical Testing of Experimental Carbon-Containing Anode Materials 6, 7 and 8 Three-Electrode Full-Cell

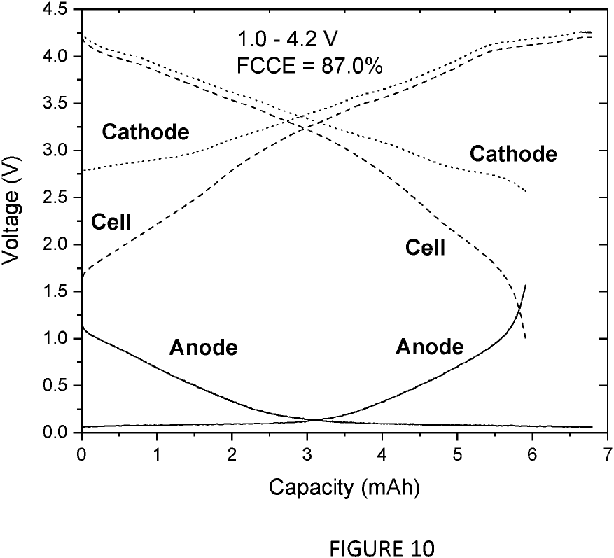

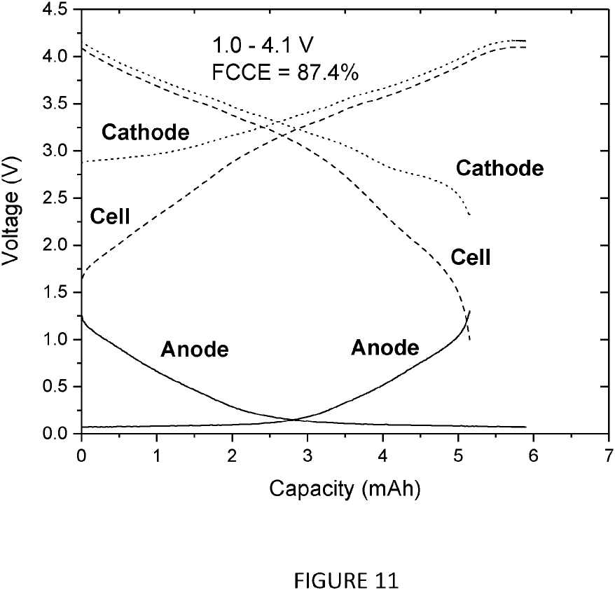

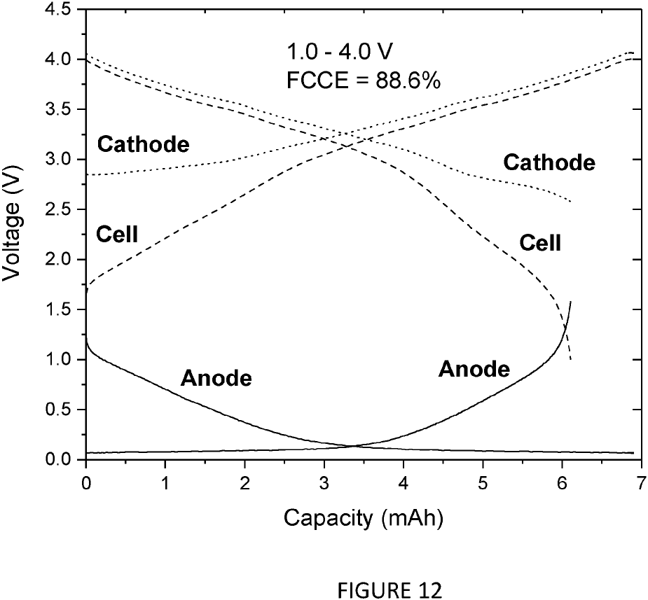

FIGS. 10-12 show the anode and cathode sodiation and desodiation potential curves together with the cell voltage as functions of cell capacity at three voltage windows: 1.0 - 4.2 V, 1.0 - 4.1 V and 1.0 - 4.0 V. The cells feature experimental carbon-containing anode materials 7, 8 and 6, respectively. The objective of the three-electrode full-cell study was to gauge the anode potential at the top of charge and investigate the likelihood of dendrites formation on the surface of anode. The fact that the anode potential at top of charge in all the voltage windows was safely positive indicates that Na-ion cells featuring the carbon-containing materials are free from the risk of dendrites formation. Due to the presence of the Na metal reference in between the anode and cathode, such three-electrode full-cell design is not optimum to achieve the highest first-cycle columbic efficiencies. Therefore, the carbon containing anode material was further tested in 0.1 Ah full cells to verify the true first-cycle columbic efficiency values.

### Electrochemical Testing of Experimental Carbon-Containing Anode Material 6-11 and 4 (Control) - Full-Cell

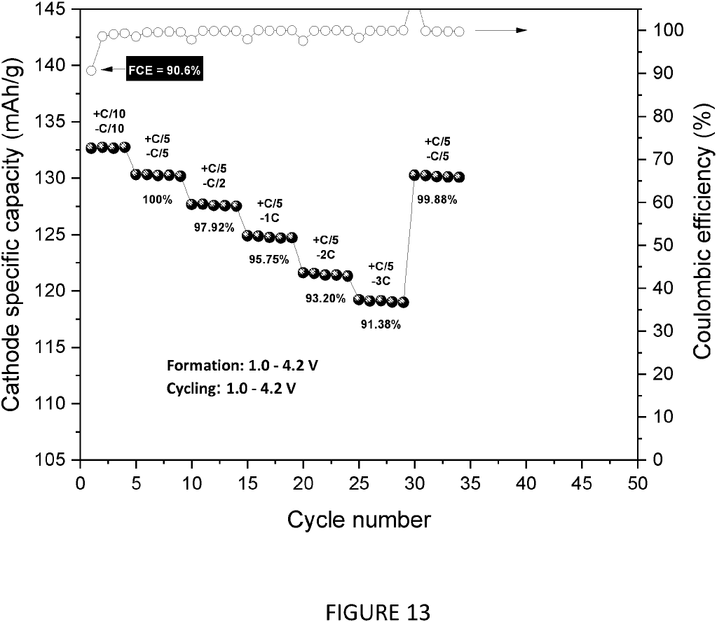

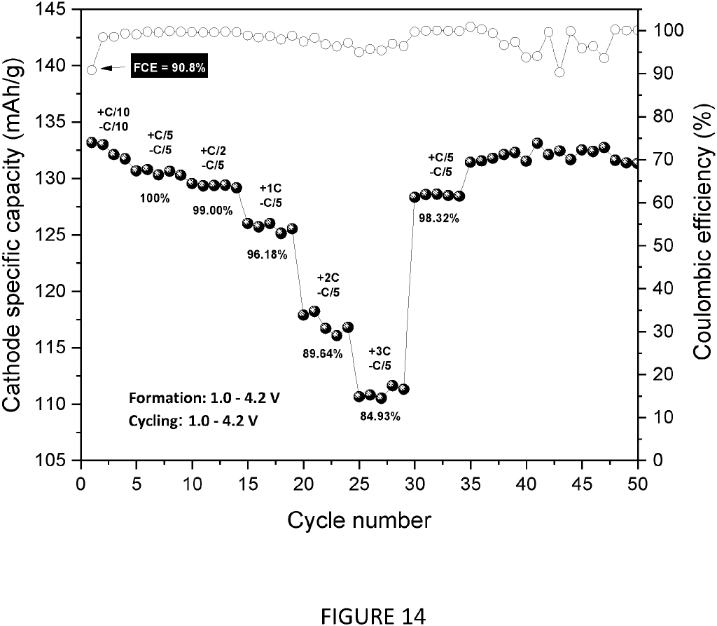

FIGS. 13 and 14 show the columbic efficiency and the cathode specific discharge capacity of two comparable cells featuring experimental carbon-containing anode material 8 as anode as functions of the cycle number. After four formation cycles of C/10 charge and discharge, the cell in FIG. 13 was charged at C/5 and discharged at various rates from C/5 up to 3C while the cell in FIG. 14 - following the same formation protocol - was charged at various rates from C/5 to 3C and discharged at C/5. Both cells had first-cycle efficiencies of >90% and exhibited > 98% capacity retention after fast charge/discharge cycles. This demonstrates that the carbon-containing anode materials according to the present invention have excellent fast charge and fast discharge capabilities. This is likely originated from enhanced electronic charge carrier characteristics of the invented material.

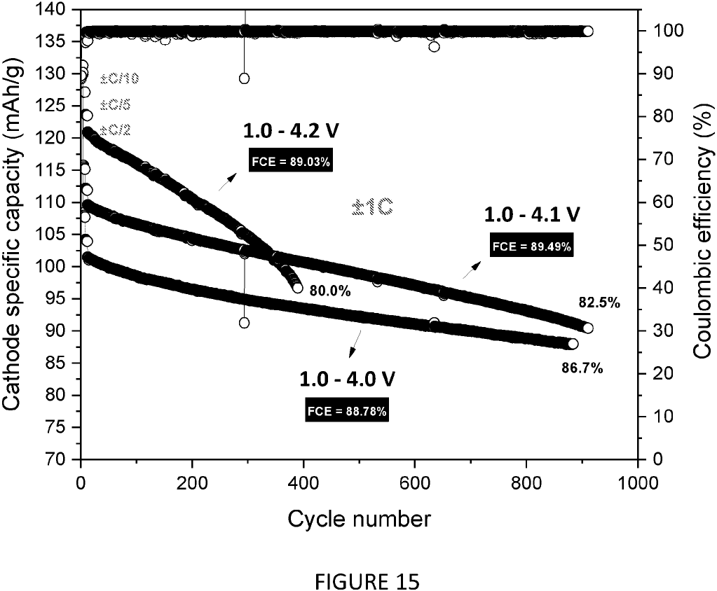

FIG. 15 compares the cycling stability of three cells featuring experimental carbon containing anode materials 6 and 8 at three different voltage windows. After four formation cycles of C/10 charge and discharge, all three cells where charged and discharged at C/5 and C/2 (four cycles each) and then charged and discharged at 1C. All three cells had first-cycle efficiencies of ca. 89%. The cells cycled at 1.0 - 4.0 V and 1.0 - 4.1 V featured experimental carbon-containing anode material 6. The cell cycled at 1.0 - 4.2 V featured experimental carbon-containing anode material 8.

Table 4 summarises the FCL, anode irreversible specific capacity and cathode reversible specific capacity of full-cells featuring various experimental carbon-containing anode materials.

TABLE 4

| Experimental material | FCL (%) | Anode irreversible specific capacity (mAh/g | Cathode reversible specific capacity (mAh/g) |
|---|---|---|---|
| 4 (control) | 16.81 ± 0.62 | 54.90 ± 1.77 | 120.61 ± 2.31 |
| 6 | 8.81 ± 0.89 | 28.07 ± 3.63 | 129.95 ± 3.83 |
| 7 | 11.20 ± 1.36 | 35.16 ± 4.75 | 130.12 ± 1.70 |
| 8 | 10.05 ± 0.65 | 32.31 ± 2.46 | 132.52 ± 1.86 |
| 9 | 10.74 ± 0.23 | 36.97 ± 0.76 | 130.01 ± 0.13 |
| 10 | 10.37 ± 0.98 | 34.12 ± 3.69 | 128.78 ± 0.09 |
| 11 | 14.51 | 48.98 | 123.02 |

In order to appreciate the true performance improvements (reduced anode irreversible specific capacity and first-cycle loss), four like-for-like benchmark full-cells featuring the carbon-containing anode material 4 (control) were charged and discharged following the same protocol as that used for full-cells featuring experimental carbon-containing anode material 6-11. The first-cycle loss, anode irreversible specific capacities and cathode reversible specific capacity values are summarised in Table 4.

As can be seen from the Table 4, the FCL and anode irreversible specific capacities of benchmark full-cells featuring carbon-containing anode material 4 (control) were significantly and systematically higher than those observed in full-cells featuring experimental carbon-containing anode materials 6-10. The higher FCL resulted in the control cells exhibiting ca. 10 mAh/g less cathode reversible specific capacity values compared to those seen from the cells featuring experimental carbon-containing anode materials 6-9.

Experimental carbon-containing anode material 11 did not exhibit as low FCL and anode irreversible specific capacity values as those obtained for experimental carbon-containing anode materials 6-10, nevertheless, the results for anode material 11 are still lower than those of the control sample 4. It is believed that the surface-treating the primary carbon-containing materials up to a maximum of 900° C. is most favourable to avoid carbon species being graphitised to an extent that inhibits reversible (de)sodiation. In conclusion, the maximum efficiencies are shown to be obtained when the primary carbon-containing materials are treated according to the present invention and at temperatures between 780 - 900° C.

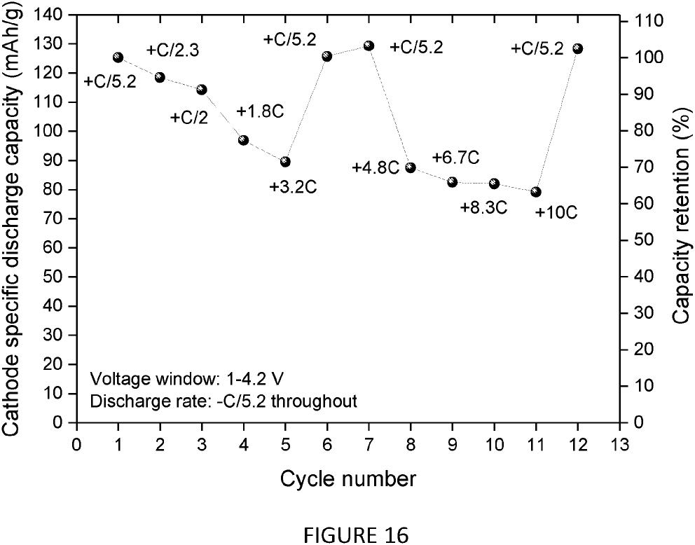

A full-cell comprising anode featuring experimental material 8 was progressively charged from C/5 to 10C with a constant discharge rate of C/5. More than 60% retention of discharge capacity was demonstrated throughout the test. Close to 100% of the rated capacity, i.e. the cathode discharge capacity when the cell was charged and discharged at C/5, was obtained after finishing the fast-charge test. The results are summarised in Table 5 and FIG. 16.

TABLE 5

| Nominal* charge rate | Actual charge time (h) | Cathode specific discharge capacity (mAh/g) | Capacity retention (%) |
|---|---|---|---|
| C/5 | 5.23 | 125.3 | 100.0 |
| C/2 | 1.99 | 114.2 | 91.2 |
| 2C | 0.56 | 96.8 | 77.3 |
| 3C | 0.31 | 89.5 | 71.4 |
| 5C | 0.21 | 87.4 | 69.8 |
| 7C | 0.15 | 82.5 | 65.8 |
| 8C | 0.12 | 81.9 | 65.4 |
| 10C | 0.10 | 79.2 | 63.2 |

* Approximate

### Experiments to Demonstrate the Reduced Moisure Sensitivity of The Carbon-Containing Anode Materials According to the Present Invention

It is highly preferred to reduce the residual moisture content of all the cell components including the electrodes, separators and electrolyte. A key advantage of the carbon-containing anode materials according to the present invention (experimental materials 6 - 11) is that they are found to be significantly less sensitive to moisture exposure than the pristine primary carbon-containing material without treatment with a carbonised material (experimental material 4 (control)).

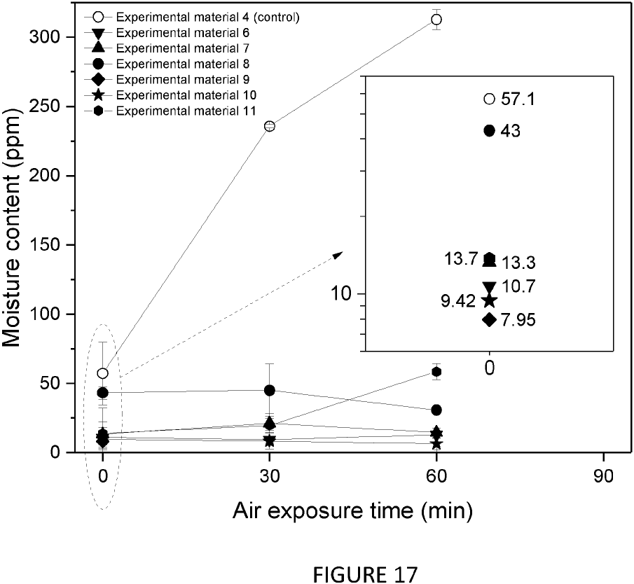

The moisture content of experimental carbon-containing anode materials 6-11 as well as the control material 4 at different exposure durations is detailed in Table 3 and FIG. 17. It is evident that the control material 4 adsorbs large quantities of moisture upon exposure while the carbon-containing anode materials according to the present invention have a significantly reduced moisture adsorption rate. As described above, it is believed that this decreased moisture absorption is due to the reduced availability of the surface micropores following treating the primary hard carbon material in the presence of a carbonised material.

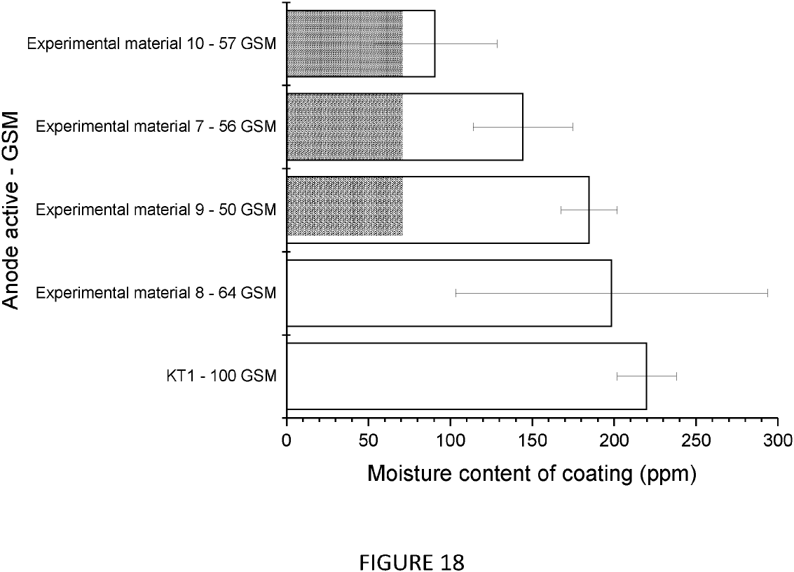

FIG. 18 shows the residual moisture content of anode electrode (coating) featuring control material 4 as well as anode electrodes (coatings) featuring carbon-containing materials according to the present invention (experimental material 7 - 10). The anode electrode (coating) that contained experimental carbon-containing material 10 exhibited the lowest (most favourable) residual moisture content.

1-15. (canceled)

16. A carbon-containing anode material which is capable of the insertion and extraction of alkali metal ions and which has a carbon structure comprising a core comprising one or more primary carbon-containing materials, and an outer surface comprising one or more carbonised materials chemically bonded and deposited substantially uniformly on the one or more primary carbon-containing materials, wherein the carbon-containing anode material has an open micropore specific surface area of 0 m²/g to 5 m²/g, as determined using nitrogen gas BET analysis, and wherein the core does not consist or consist essentially of one or more primary carbon-containing materials selected from graphite and a material that has a fully graphitic structure.

17. A carbon-containing anode material according to claim 16 wherein the one or more primary carbon-containing materials comprise a graphitisable domain and a non-graphitised domain.

18. A carbon-containing anode material according to claim 16 wherein the one or more primary carbon-containing materials comprise a non-graphitisable domain and a non-graphitised domain.

19. A carbon-containing anode material according to claim 16 wherein the one or more primary carbon-containing materials are derived from the pyrolysis of plant-based materials, animal-derived materials, hydrocarbon materials, carbohydrate materials and other carbon-containing organic materials.

20. A carbon-containing anode material according to claim 16 wherein the one or more primary carbon-containing materials comprise one or more carbon composite materials represented by: (carbon)-X
where X is one or more elements selected from the group consisting of antimony, tin, phosphorus, sulfur, boron, aluminium, gallium, indium, germanium, lead, arsenic, bismuth, titanium, molybdenum, selenium, tellurium, silicon, carbon and magnesium; or
where X is one or more oxides of elements selected from the group consisting of antimony, tin, phosphorus, sulfur, boron, aluminium, gallium, indium, germanium, lead, arsenic, bismuth, titanium, molybdenum, selenium, tellurium, silicon, carbon and magnesium.

21. A carbon-containing anode material according to claim 16 wherein the carbonised material is derived from one or more secondary carbon-containing materials selected from organic and hydrocarbon materials.

22. A carbon-containing anode material according to claim 16 comprising a maximum of 2.5 atomic percent of oxygen on its outer surface.

23. A carbon-containing anode material according to claim 16 that has a maximum of 50 parts per million of moisture, as determined using Karl Fischer titration technique and after exposure to ambient atmosphere up to one hour.

24. A carbon-containing anode material according to claim 16 wherein the one or more primary carbon-containing materials have a particle size from 1 nm to 30 µm.

25. A process for the preparation of a carbon-containing anode material which is capable of the insertion and extraction of alkali metal ions and which has a carbon structure comprising: contacting a core comprising one or more primary carbon-containing materials in solid form with carbonised material at a temperature of up to 950° C., to thereby yield a carbon-containing anode material that has one or more carbonised materials chemically bonded and deposited substantially uniformly on an outer surface of the one or more primary carbon-containing materials and wherein the carbon-containing anode material has an open micropore specific surface area of 0 m²/g to 5 m²/g as determined using nitrogen gas BET analysis, and wherein the core does not consist or consist essentially of one or more primary carbon-containing materials selected from graphite, and a material that has a fully graphitic structure.

26. A process according to claim 25 wherein the step of contacting the primary carbon-containing materials with the carbonised material is achieved by contacting the primary carbon-containing materials with one or more secondary carbon-containing materials and thereafter facilitating the formation of carbonised material from the one or more secondary carbon-containing materials.

27. A process according to claim 26 wherein the one or more secondary carbon-containing materials comprise a vapour and/or a liquid and/or gaseous phase at, at least one temperature from 950° C. or less.

28. A sodium-ion cell comprising a cathode electrode, an anode electrode and an electrolyte, wherein the anode electrode comprises a carbon-containing anode material according to claim 16.

29. The sodium-ion cell according to claim 28 wherein the electrolyte comprises one or more selected from: > 0 to 10 molar sodium metal salts selected from NaPF₆, NaBF₄, sodium bis(oxalate) (NaBOB), sodium triflate (NaOTf), in one or more solvents selected from ethylene carbonate (EC), diethyl carbonate (DEC), propylene carbonate (PC), dimethyl carbonate (DMC), ethyl methyl carbonate (EMC), gamma butyrolactone (GBL) sulfolane, diglyme, triglyme, tetraglyme, dimethyl sulfoxide (DMSO), dioxolane, and mixtures thereof; NASICON-type electrolytes, sulphide-based electrolytes, hydride-based electrolytes, β-alumina based electrolytes and β″-alumina based electrolytes.

30. A lithium-ion cell comprising a cathode electrode, an anode electrode and an electrolyte, wherein the anode electrode comprises a carbon-containing anode material according to claim 16.

31. The lithium-ion cell according to claim 30 wherein the electrolyte comprises, LiPF₆, LiAsF₆, LiBF₄, LiBOB, LiClO₄, LiFSi, LiTFSi, Li-triflate and mixtures thereof, and one or more solvents selected from ethylene carbonate (EC), diethyl carbonate (DEC), propylene carbonate (PC), dimethyl carbonate (DMC), ethyl methyl carbonate (EMC), gamma butyrolactone (GBL) sulfolane, diglyme, triglyme, tetraglyme, dimethyl sulfoxide (DMSO), dioxolane, and mixtures thereof.

32. An alkali metal-ion cell comprising an anode electrode comprising one or more materials according to claim 16 which have a moisture content of less than 200 parts per million, as determined using Karl Fischer titration technique.
